(19) United States
(12) Patent Application Publication
(10) Pub. No.: US 2021/0191071 A1
(43) Pub. Date: Jun. 24, 2021

(54) OPTICAL ELEMENT UNIT

(71) Applicant: DISCO CORPORATION, Tokyo (JP)

(72) Inventors: Osamu OMACHI, Tokyo (JP); Takeshi DEJIMA, Tokyo (JP); Junichi KUKI, Tokyo (JP)

(21) Appl. No.: 17/120,711

(22) Filed: Dec. 14, 2020

(30) Foreign Application Priority Data
Dec. 23, 2019 (JP) 2019-231140

(51) Int. Cl. G02B 7/182

(52) U.S. Cl. CPC G02B 7/182

(57) ABSTRACT

An optical element unit includes a reflective optical element and a support that, when the optical element is disposed at a predetermined position in an optical system, is fixed by a fixing device to support the optical element. The support is configured so that, owing to the fixing of the support by the fixing device, a strain to be produced in the optical element upon fixing the optical element is reduced compared with a case in which the optical element is fixed directly by the fixing device.

### BACKGROUND OF THE INVENTION

### Field of the Invention

The present invention relates to an optical element unit including a reflective optical element represented by a mirror.

### Description of the Related Art

When dividing a plate-shaped workpiece typified by a semiconductor wafer into a plurality of chips, a laser processing apparatus with a laser oscillator and optical elements such as mirrors and lenses included therein may be used (see, for example, JP 2007-275912A). By irradiating a laser beam, which has been generated at the laser oscillator, to a workpiece along streets (scheduled division lines) as boundaries of chips via a variety of optical elements, the workpiece can be divided into the chips along the streets.

### SUMMARY OF THE INVENTION

When building an optical system in the above-mentioned laser processing apparatus, optical elements are often disposed at respective predetermined positions, in the optical system by using, for example, fixing devices (holders) that can fix the optical elements. If each optical element is fixed by the fixing device, however, the optical element may be deformed by a stress applied from the fixing device to the optical element so that the shape of the wave front of a laser beam may fall outside from a permissible range.

If this is the case, an increase occurs, for example, in astigmatism, leading to a decrease in the accuracy of processing by the laser processing apparatus. This problem becomes particularly serous if a reflective optical element represented by a mirror is fixed by a fixing device, because the reflective optical element is prone to effects of a strain compared with a transmissive optical element.

Further, with this fixing method, it is difficult to make a stress, which is applied from a fixing device to an optical element, equal among a plurality of laser processing apparatuses, thereby tending to develop differences in processing accuracy among the laser processing apparatuses. To eliminate such a problem, it may be contemplated, for example, to control a stress, which is to be applied to an optical element, based on a tightening torque or the like when fixing the optical element by a fixing device. However, there are individual differences among fixing devices, so that optical elements will not necessarily have an equal strain even if they are fixed with the same fastening torque or the like.

It may also be contemplated to measure the strain of an optical element after fixing the optical element by a fixing device. However, this method requires a lot of time for the measurement of the strain, and moreover cannot fundamentally suppress problems caused by the strain. Adoption of a large optical element can make effects of a strain correspondingly smaller. If this is the case, however, the laser processing apparatus is prone to increase in size. In addition, it is not practical to adopt a large optical element when improving the optical system of an existing laser processing apparatus.

The present invention therefore has as an object the provision of an optical element unit that can build an optical system with high accuracy even if an existing fixing device is used.

In accordance with an aspect of the present invention, there is provided an optical element unit including a reflective optical element, and a support that, when the optical element is disposed at a predetermined position in an optical system, is fixed by a fixing device to support the optical element. The support is configured so that, owing to the fixing of the support by the fixing device, a strain to be produced in the optical element upon fixing the optical element is reduced compared with a case in which the optical element is fixed directly by the fixing device.

Preferably, the support may include a first surface, a second surface on a side opposite to the first surface, and an accommodating portion opening in one of or both the first surface and the second surface, and configured to accommodate a part or an entire part of the optical element therein so that the optical element is supported.

Preferably, the optical element may be supported on the support via an adhesive.

Preferably, the optical element may be supported on the support via one or more elastic members.

Preferably, the support may be formed with one or more materials selected from aluminum, stainless steel, Invar, Kovar, ceramics, and fluorinated resins.

The optical element unit according to the aspect of the present invention includes the support that is fixed by the fixing device when disposing the reflective optical element at the predetermined position in the optical system, and the optical element is supported by the support. In other words, the optical element is not fixed directly by the fixing device, so that no large strain is produced in the optical element by a stress or the like which acts from the fixing device. Therefore, the use of the optical element unit according to the aspect of the present invention enables to build an optical system with high accuracy by using an existing fixing device.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view of an optical element unit according to an embodiment of the present invention;

FIG. 2 is a perspective view of a support included in the optical element unit;

FIG. 3 is a perspective view of the support, which is included in the optical element unit, as viewed from a direction opposite to that in FIG. 2;

FIG. 4 is a perspective view of a fixing device for use upon fixing the optical element unit;

FIG. 5 is a perspective view of the fixing device, which is for use upon fixing the optical element unit, as viewed from a direction different from that in FIG. 4;

FIG. 6 is a cross-sectional view illustrating the optical element unit fixed on the fixing device;

FIG. 7 is a perspective view of a support according to a first modification;

FIG. 8 is a perspective view of the support according to the first modification as viewed from a direction opposite to that in FIG. 7;

FIG. 9 is a perspective view of a support according to a second modification; and

FIG. 10 is a perspective view of the support according to the second modification as viewed from a direction opposite to that in FIG. 9.

### DETAILED DESCRIPTION OF THE PREFERRED EMBODIMENT

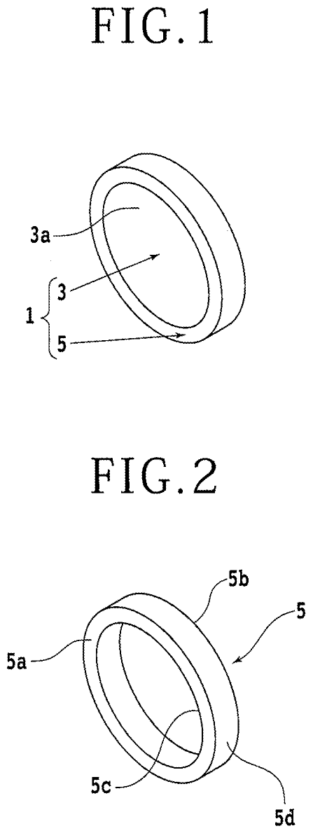

With reference to the attached drawings, a description will hereinafter be made about an embodiment of the present invention and modifications thereof. FIG. 1 is a perspective view of an optical element unit 1 according to this embodiment. As illustrated in FIG. 1, the optical element unit 1 includes a reflective optical element 3 formed in a disc shape, and a support 5 supporting the optical element 3 at an outer peripheral portion thereof. The optical element 3 has a surface 3a, typically a mirror or the like, on which light such as a laser beam impinges. The optical element 3 is disposed at a predetermined position in an optical system that configures, for example, a laser processing apparatus or the like (not illustrated).

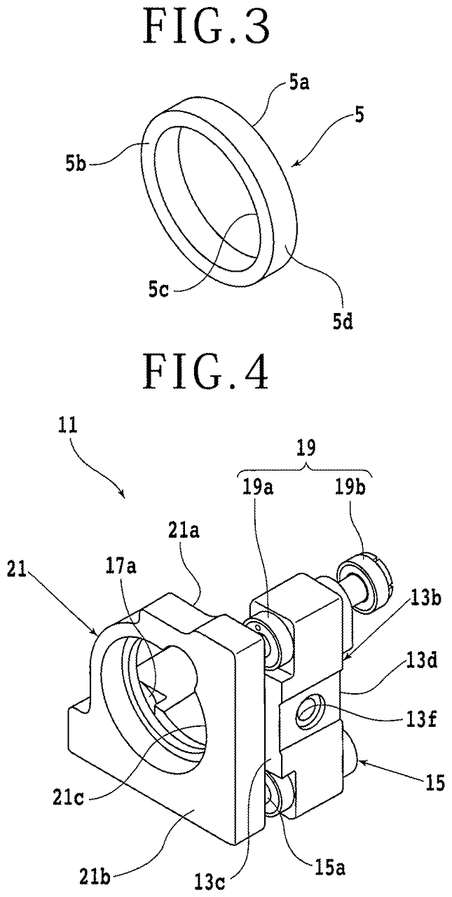

FIG. 2 is a perspective view of the support 5 included in the optical element unit 1, and FIG. 3 is a perspective view of the support 5 as viewed from a direction opposite to that in FIG. 2. The support 5 is formed, for example, with aluminum in a cylindrical shape, and has a first surface 5a equivalent to a bottom surface, and a second surface 5b equivalent to another bottom surface on a side opposite to the first surface 5a. The first surface 5a and the second surface 5b have outer edges, for example, of a circular shape having the same diameter.

No particular limitation is imposed on the material that forms the support 5. For example, the support 5 may be formed using another metal such as stainless steel, an alloy such as Invar (nickel-iron alloy) having a small coefficient of thermal expansion around room temperature or Kovar (nickel-cobalt ferrous alloy) having a coefficient of thermal expansion close to that of borosilicate glass, a ceramic represented by alumina or quartz, or a fluorinated resin. The support 5 may be formed using a plurality of materials selected from such metals, ceramics and fluorinated resins.

The support 5 may desirably be formed using a material that has a coefficient of thermal expansion close to that of the material forming the optical element 3. If this is the case, the degree of a deformation due to a change in temperature is close between the optical element 3 and the support 5. Even if the temperature changes, a force is hardly applied from the support 5 to the optical element 3, thereby facilitating to suppress a strain in the optical element 3. If borosilicate glass is used in the optical element 3, for example, the support 5 may preferably be formed using Kovar that has the coefficient of thermal expansion close to that of borosilicate glass.

An accommodating portion 5c of a size and a shape that can accommodate the optical element 3 is formed in the support 5. The accommodating portion 5c opens in both a central part of the first surface 5a and a central part of the second surface 5b and is in communication with an outside of the support 5. Described specifically, the first surface 5a and the second surface 5b are each formed in an annular shape having an opening at a central part thereof. The optical element 3 is inserted into the accommodating portion 5c through the opening in the first surface 5a or the second surface 5b.

When inserting the optical element 3 into the accommodating portion 5c, an adhesive is applied, for example, to an outer peripheral surface of the optical element 3 or to an inner wall surface of the accommodating portion 5c, and the optical element 3 is fixed by the adhesive on the support 5. In other words, the optical element 3 is supported on the support 5 via the adhesive. If the optical element unit 1 is used in an optical system for a high-output laser beam in the laser processing apparatus or the like, the optical element 3 may desirably be fixed on the support 5 with an adhesive that is resistant to deteriorations by light, heat, or the like.

If the optical element 3 is fixed on the support 5 with an adhesive prone to deteriorations by light, heat, or the like (typically, an adhesive such as giving off gas by light, heat, or the like), for example, the optical element 3 may significantly deform under the effects of deteriorations of the adhesive. In contrast, the use of an adhesive resistant to deteriorations by light, heat, or the like can sufficiently reduce strains that are to occur in the optical element 3 due to deteriorations of the adhesive.

As an alternative, the optical element 3 may be supported on the support 5 via one or more elastic members, such as leaf springs, that produce a restoring force. Also in this case, strains to be produced in the optical element 3 can sufficiently be reduced by appropriately adjusting the restoring force of the elastic member. As a further alternative, the optical element 3 can be fixed on the support 5 with a nonvolatile liquid represented by gallium.

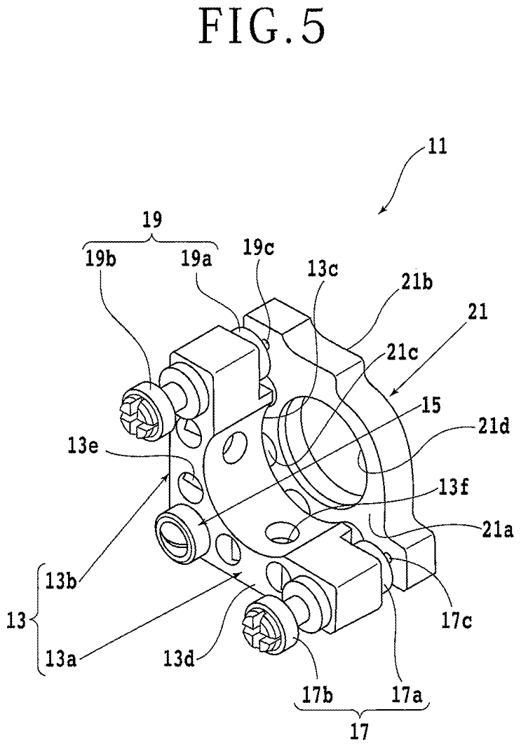

FIG. 4 is a perspective view of a fixing device (holder) 11 for use upon fixing the optical element unit 1, and FIG. 5 is a perspective view of the fixing device 11 as viewed from a direction different from that in FIG. 4. The fixing device 11 includes a stage 13 (FIG. 5) to be fixed, for example, on a frame or the like of the laser processing apparatus. The stage 13 includes a first portion 13a that is long in a first direction, and a second portion 13b that is long in a second direction perpendicular to the first direction. The stage 13 is formed in a substantially L-shape that the first portion 13a and the second portion 13b are connected to each other on the sides of one end portions thereof (on the side of proximal end portions thereof).

At a connecting portion between the first portion 13a and the second portion 13b, a through-hole (not illustrated) as a fulcrum is formed extending in a third direction that is perpendicular to the first direction and the second direction. In this through-hole as the fulcrum, a fulcrum mechanism 15 is installed. The fulcrum mechanism 15 extends at a tip portion 15a thereof toward an outer side beyond a first surface 13c of the stage 13, the first surface 13c being located on one side of the stage 13 as viewed in the third direction.

At an opposite end portion (a distal end portion) of the first portion 13a, a first fine positioning through-hole (not illustrated) is formed extending in the third direction through the stage 13. In this first fine positioning through-hole, a first fine positioning mechanism 17 is installed. The first fine positioning mechanism 17 includes an internally threaded member 17a, which is fixed on the side of the first surface 13c of the stage 13 and has a screw thread on an inner peripheral surface thereof.

Into the internally threaded member 17a, an externally threaded member 17b, which has a screw thread on an outer peripheral surface thereof, is inserted through the first fine positioning through-hole from the side of a second surface 13d opposite to the first surface 13c of the stage 13. The externally threaded member 17b extends at a tip portion 17c thereof toward an outside of the first surface 13c of the stage 13. If the externally threaded member 17b is rotated relative to the internally threaded member 17a, the amount of protrusion of the tip portion 17c from the first surface 13c changes.

Similarly, at an opposite end portion (a distal end portion) of the second portion 13b, a second fine positioning through-hole (not illustrated) is formed extending in the third direction through the stage 13. In this second fine positioning through-hole, a second fine positioning mechanism 19 is installed. The second fine positioning mechanism 19 includes an internally threaded member 19a, which is fixed on the side of the first surface 13c of the stage 13 and has a screw thread on an inner peripheral surface thereof.

In the internally threaded member 19a, an externally threaded member 19b, which has a screw thread on an outer peripheral surface thereof, is inserted through the second fine positioning through-hole from the side of the second surface 13d of the stage 13. The externally threaded member 19b extends at a tip portion 19c thereof toward an outside of the first surface 13c of the stage 13. If the externally threaded member 19b is rotated relative to the internally threaded member 19a, the amount of protrusion of the tip portion 19c from the first surface 13c changes.

A flat plate-shaped mounter 21, to which the optical element unit 1 is to be attached, is disposed on the side of the first surface 13c of the stage 13. The mounter 21 has a first surface 21a facing the first surface 13c of the stage 13, and a second surface 21b located on a side opposite to the first surface 21a. The stage 13 and the mounter 21 are connected together so that the first surface 13c and the first surface 21a pull each other via a plurality of elastic members (unillustrated) such as tension coil springs.

Therefore, the tip portion 15a of the fulcrum mechanism 15, the tip portion 17c of the first fine positioning mechanism 17, and the tip portion 19c of the second fine positioning mechanism 19 come to contact with the first surface 21a of the mounter 21. Accordingly, the mounter 21 is supported at three points of the tip portion 15a of the fulcrum mechanism 15, the tip portion 17c of the first fine positioning mechanism 17, and the tip portion 19c of the second fine positioning mechanism 19.

If the amount of protrusion of the tip portion 17c of the first fine positioning mechanism 17 is changed by rotating the externally threaded member 17b relative to the internally threaded member 17a with the amount of protrusion of the tip portion 19c of the second fine positioning mechanism 19 maintained constant, the mounter 21 rotates about an axis of rotation that connects the tip portion 15a of the fulcrum mechanism 15 and the tip portion 19c of the second fine positioning mechanism 19 together.

Similarly, if the amount of protrusion of the tip portion 19c of the second fine positioning mechanism 19 is changed by rotating the externally threaded member 19b relative to the internally threaded member 19a with the amount of protrusion of the tip portion 17c of the first fine positioning mechanism 17 maintained constant, the mounter 21 rotates about an axis of rotation that connects the tip portion 15a of the fulcrum mechanism 15 and the tip portion 17c of the first fine positioning mechanism 17 together.

As a consequence, the angle of the mounter 21 to the stage 13 is changed so that the direction of the optical element unit 1 attached to the mounter 21 can be adjusted. The respective elastic members, via which the stage 13 and the mounter 21 are connected together, are each held at one end portion thereof by one of a plurality of holding portions 13e on the side of the stage 13, and at an opposite end portion thereof by one of a plurality of holding portions 21c on the side of the mounter 21.

At a position on the mounter 21 where the mounter 21 does not overlap the stage 13 as viewed from the third direction, an accommodating portion 21d of a size and a shape that can accommodate the optical element unit 1 is formed. The accommodating portion 21d opens in the first surface 21a and the second surface 21b and is in communication with an outside of the mounter 21. Therefore, the first surface 21a and the second surface 21b each have an opening.

The opening on the side of the second surface 21b, for example, has a shape and a size corresponding to those of the optical element unit 1 (specifically, the outer peripheral surface 5d of the support 5), so that the optical element unit 1 is inserted into the accommodating portion 21d through the opening on the side of the second surface 21b. On the other hand, the opening on the side of the first surface 21a is set smaller to such an extent that the optical element unit 1 does not fall out of the accommodating portion 21d through the opening on the side of the first surface 21a.

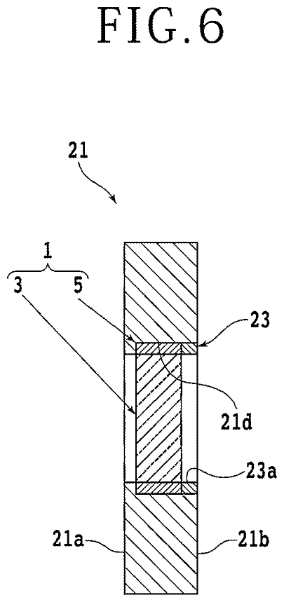

FIG. 6 is a cross-sectional view illustrating the optical element unit 1 fixed on the fixing device 11. A screw thread is formed in an inner peripheral surface of the accommodating portion 21d in a region on the side of the second surface 21b. The optical element unit 1 can therefore be fixed on the mounter 21 of the fixing device 11, for example, if a threaded ring 23 with a screw thread formed in an outer peripheral surface thereof is fastened in the accommodating portion 21d with the optical element unit 1 accommodated in the accommodating portion 21d.

In a central portion of the threaded ring 23, a through-hole 23a of a shape and a size corresponding to those of the optical element 3 is formed. Therefore, the laser beam that is to impinge on the optical element 3 is not blocked by the threaded ring 23. Further, the optical element unit 1 can be fixed on the mounter 21 of the fixing device 11 by bringing the threaded ring 23 into contact with the support 5 without contact to the optical element 3. Therefore, the optical element 3 is not fixed directly on the fixing device 11.

When disposing the optical element 3 at the predetermined position in the optical system that configures the laser processing apparatus or the like, the fixing device 11 is fixed at a desired position of the frame or the like of the laser processing apparatus. Described specifically, bolts or the like are fastened through through-holes 13f (FIG. 5), which are formed in the stage 13 of the fixing device 11, to the frame or the like of the laser processing apparatus. As a consequence, the optical element 3 in the optical element unit 1 fixed on the mounter 21 can be disposed at the predetermined position in the optical system.

A description will next be made about an experiment, which was conducted to confirm performance of the optical element unit 1 of this embodiment, and its results. In the experiment, a measurement was made of the magnitude of astigmatism generated by the optical element 3 when the optical element unit 1 was fixed using the above-mentioned fixing device 11. Described specifically, the extent of astigmatism generated by the optical element 3 was quantified based on the coefficients of the astigmatism term in the Zernike polynomials.

The above-mentioned measurement was made on a plurality of samples of the optical element unit 1, followed by a confirmation as to whether or not the samples each achieved a reference value (in other words, whether or not the samples each fell below the reference value). As a comparative example, a similar measurement was made about a case in which the optical element was fixed directly by the fixing device 11. The results of the experiment are presented in Table 1.

TABLE 1

| | Number of samples | Number of samples |
|---|---|---|
| | achieved the | failed to achieve |
| | reference value | the reference value |
| Embodiment | 10 | 0 |
| Comparative | 6 | 4 |
| example | | |

As envisaged from Table 1, all the samples were able to achieve the reference value (achievement rate: 100%) in the optical element unit 1 of this embodiment, while 40% of the samples failed to achieve the reference value (achievement rate: 60%) in a case in which the optical element was fixed directly by the fixing device 11. The optical element unit 1 of this embodiment is therefore considered to be extremely effective for the suppression of astigmatism.

As described above, the optical element unit 1 according to this embodiment includes the support 5 that is fixed by the fixing device 11 when disposing the reflective optical element 3 at the predetermined position in the optical system, and the optical element 3 is supported by the support 5. In other words, the optical element 3 is not fixed directly by the fixing device 11, so that no large strain is produced in the optical element 3 by a stress or the like which acts from the fixing device 11. Therefore, the use of the optical element unit 1 according to this embodiment enables to build an optical system with high accuracy by using the existing fixing device 11.

The present invention can be carried out with various changes without being limited to the description of the above-mentioned embodiment. For example, the thickness (the distance between the first surface 5a and the second surface 5b) of the support 5 is set at an equal level to that of the optical element 3 in the above-mentioned embodiment. However, the thickness of the support 5 may be set, for example, smaller than that of the optical element 3. Conversely, the thickness of the support 5 may be set greater than that of the optical element 3. In other words, the accommodating portion 5c may be configured to enable accommodation of only a portion of the optical element 3 or may be configured to enable accommodation of the optical element 3 in its entirety.

In the above-mentioned embodiment, the description is made about the optical element unit 1 including the cylindrical support 5 having the openings of the same size and shape in the central part of the first surface 5a and the central part of the second surface 5b, respectively, although no limitation is imposed on the structure of the support included in the optical element unit of the present invention. The support is only required to be able to support the optical element 3 at at least a portion thereof, and may be configured, for example, to be able to support the optical element 3 at two positions that are apart from each other. In addition, the support may have a U-shaped external shape. Similarly, no limitations are imposed on the shape, the size, the position, and the like of the opening included in the support.

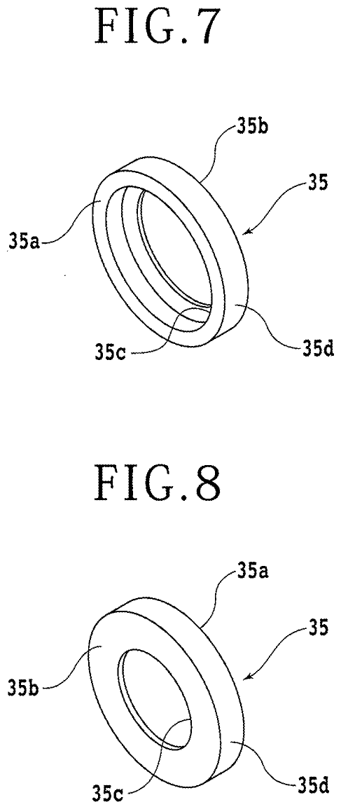

FIG. 7 is a perspective view of a support 35 according to a first modification, and FIG. 8 is a perspective view of the support 35 according to the first modification as viewed from a direction opposite to that in FIG. 7. As illustrated in FIGS. 7 and 8, the support 35 is formed in a cylindrical shape with a similar material to that of the support 5 in the above-mentioned embodiment, and has a first surface 35a equivalent to a bottom surface, and a second surface 35b equivalent to another bottom surface on a side opposite to the first surface 35a. The first surface 35a and the second surface 35b have outer edges, for example, of a circular shape having the same diameter.

An accommodating portion 35c of a size and s shape that can accommodate the optical element 3 in the above-mentioned embodiment is formed in the support 35. The accommodating portion 35c opens in both a central part of the first surface 35a and a central part of the second surface 35b and is in communication with an outside of the support 35. In other words, the first surface 35a and the second surface 35b are each formed in an annular shape having an opening at a central part thereof.

However, the opening in the second surface 35b has a size smaller than that of the opening in the first surface 35a, so that the optical element 3 cannot pass through the opening in the second surface 35b. Hence, the optical element 3 is inserted into the accommodating portion 35c through the opening in the first surface 35a. The support 35 also includes an outer peripheral surface 35d, which may have the same size and shape as those of the outer peripheral surface 5d of the above-mentioned support 5.

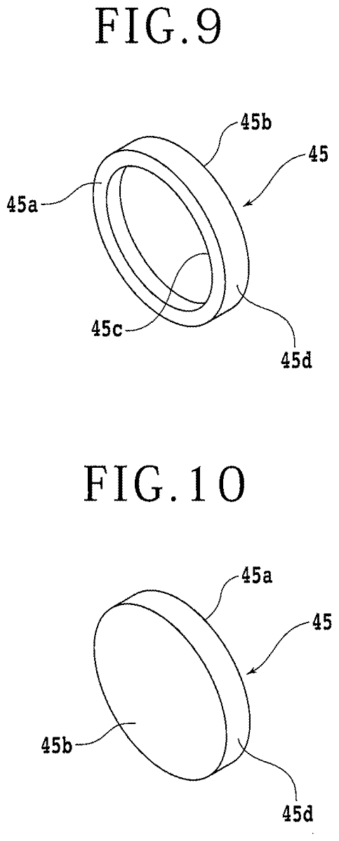

FIG. 9 is a perspective view of a support 45 according to a second modification, and FIG. 10 is a perspective view of the support 45 according to the second modification as viewed from a direction opposite to that in FIG. 9. As illustrated in FIGS. 9 and 10, the support 45 is formed in a bottomed cylindrical shape with a similar material to that of the support 5 in the above-mentioned embodiment, and has a first surface 45a equivalent to a bottom surface, and a second surface 45b equivalent to another bottom surface on a side opposite to the first surface 45a. The first surface 45a and the second surface 45b have outer edges, for example, of a circular shape having the same diameter.

An accommodating portion 45c of a size and a shape that can accommodate the above-mentioned optical element 3 is formed in the support 45. The accommodating portion 45c opens in a central part of the first surface 45a and is in communication with an outside of the support 45. Described specifically, the first surface 45a is formed in an annular shape having an opening at a central part thereof, while the second surface 45b is formed in a circular shape having no opening at a central part thereof. The optical element 3 is inserted into the accommodating portion 45c through the opening in the first surface 45a. The support 45 also includes an outer peripheral surface 45d, which may have the same size and shape as those of the outer peripheral surface 5d of the above-mentioned support 5.

In the above-mentioned embodiment, the optical element 3 is fixed on the support 5 so that a part of the surface 3a (i.e., the surface on which the laser beam impinges) of the optical element 3 and the first surface 5a or second surface 5b of the support 5 become substantially parallel to each other. However, the optical element 3 may be fixed on the support 5 so that its surface 3a inclines with respect to the first surface 5a or the second surface 5b.

Further, in the above-mentioned embodiment, the optical element unit 1 is fixed on the mounter 21 of the fixing device 11 by using the threaded ring 23. However, the optical element unit 1 can also be fixed on the mounter 21 of the fixing device 11, for example, by a set screw or the like.

The structure, method, and the like according to the embodiment and the modifications may be changed or modified in various ways insofar without departing from the scope of the present invention.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. An optical element unit comprising:
a reflective optical element; and
a support that, when the optical element is disposed at a predetermined position in an optical system, is fixed by a fixing device to support the optical element,
wherein the support is configured so that, owing to the fixing of the support by the fixing device, a strain to be produced in the optical element upon fixing the optical element is reduced compared with a case in which the optical element is fixed directly by the fixing device.

2. The optical element unit according to claim 1,
wherein the support includes
a first surface,
a second surface on a side opposite to the first surface, and
an accommodating portion opening in one of or both the first surface and the second surface, and configured to accommodate a part or an entire part of the optical element therein so that the optical element is supported.

3. The optical element unit according to claim 1, wherein the optical element is supported on the support via an adhesive.

4. The optical element unit according to claim 1, wherein the optical element is supported on the support via one or more elastic members.

5. The optical element unit according to claim 1, wherein the support is formed with one or more materials selected from aluminum, stainless steel, Invar, Kovar, ceramics, and fluorinated resins.

6. The optical element unit according to claim 2, wherein the optical element is supported on the support via an adhesive.

7. The optical element unit according to claim 2, wherein the optical element is supported on the support via one or more elastic members.

8. The optical element unit according to claim 2, wherein the support is formed with one or more materials selected from aluminum, stainless steel, Invar, Kovar, ceramics, and fluorinated resins.

9. The optical element unit according to claim 3, wherein the support is formed with one or more materials selected from aluminum, stainless steel, Invar, Kovar, ceramics, and fluorinated resins.

10. The optical element unit according to claim 4, wherein the support is formed with one or more materials selected from aluminum, stainless steel, Invar, Kovar, ceramics, and fluorinated resins.

11. The optical element unit according to claim 6, wherein the support is formed with one or more materials selected from aluminum, stainless steel, Invar, Kovar, ceramics, and fluorinated resins.

12. The optical element unit according to claim 7, wherein the support is formed with one or more materials selected from aluminum, stainless steel, Invar, Kovar, ceramics, and fluorinated resins.
